(19) United States
(12) Patent Application Publication
(10) Pub. No.: US 2007/0053530 A1
(43) Pub. Date: Mar. 8, 2007

(54) Bone-conduction speaker device

(75) Inventors: Koichiro Ochiai, Osaka (JP); Haruhisa Yamashita, Osaka (JP); Hideaki Wakasa, Osaka (JP)

Correspondence Address: PILLSBURY WINTHROP SHAW PITTMAN, LLP, P.O. BOX 10500, MCLEAN, VA, 22102, US

(73) Assignee: TOSHIBA HA PRODUCTS CO., LTD, OSAKA (JP)

(21) Appl. No.: 10/566,650

(22) PCT Filed: Feb. 27, 2004
(86) PCT No.: PCT/JP04/02422

§ 371 Date: Feb. 1, 2006

(30) Foreign Application Priority Data
Sep. 2, 2003 (JP) 2003-310765
Sep. 2, 2003 (JP) 2003-310769

(51) Int. Cl. H04R 25/00

(52) U.S. Cl. 381/151

(57) ABSTRACT

It is aimed to provide a bone-conduction speaker device which makes no leakage of sound annoying the other and does not restrict posture and rolling-over motion of the user when lying on a bed or sitting on a sofa, and which makes highly reliable and excellent transmission and receiving of sound signal as to enable enjoying of music or the like with almost no locational restrictions. The speaker device comprises: a transmitter converting the inputted sound signal into output of infrared signal and then transmitting it; a receiver demodulating the inputted infrared signal into the sound signal; a bone-conduction speaker amplifying the sound signal and outputting it as sound vibration; and a pad-shaped elastic cushioning body holding on its surface the bone-conduction speaker, thereby forming a pad embedded with the bone-conduction speaker(s). Photo-acceptors for the receiver are arranged on fringe of the cushioning body as spaced apart to each other.

### TECHNICAL FIELD

The present invention relates to a padded or stuffed device that enables listening of music or the like by way of bone conduction and is able to be used concomitant with a pillow or the like. The present invention especially relates to a bone-conduction speaker device in which inputting of sound signal through infrared rays is improved.

### BACKGROUND ART

Conventionally, as means for listening to music, radio broadcasting or the like while lying on a bed, devices of following manner for example have been disclosed in publications of patent applications. Please see JP-2002-125825A (patent document 1) for example. Speaker devices are embedded in a main body of a pillow; and sound from the speaker devices attached on backside of coversheet of the pillow is transmitted to nearby of ear of the user, through meshed sheet on the pillow. Meanwhile, headphone devices utilizing bone conduction are also disclosed in publications of patent applications. Please see JP-2003-32768A (patent document 2) for example.

Recently, one shown as in FIG. 10 is commercialized, in which bone-conduction speakers (72) are embedded in a cushioning body (73) for receiving head of the user so that the user of the pillow (71) may listen to music while lying on a bed. Such a pillow is constructed as follows: a pillow-shaped cushioning body (73) has a skin layer that is integrally formed on a surface of a connected-cell foam body; and two bone-conduction speakers (72) are embedded as spaced with a small interval, on upper face of the cushioning body (73) so as to be abutted with head (6) of the user; and thereby, the user is able to listen to music or the like when laying his or her head on the pillow, by way of bone conduction of sound.

The device shown in the JP-2002-125825A (patent document 1) has speakers that are embedded in the main part of pillow and disposed at nearby of ears of the user. Thus, small tonal volume is enough for the listening. Nevertheless, some extent of the tonal volume remains and remaining sound may reach the others, as to have chance to annoy roommates in a quiet hospital room or the like, in particular.

The headphone or earphone device of the JP-2003-32768A (patent document 2) makes almost no leakage of sound, thus does not annoy the other when the user listens to the sound. Nevertheless, the headphone or earphone device by itself annoys the user by restricting him or her such as preventing from rolling over while lying on the bed.

According to construction shown in the FIG. 10, the head (6) of the user contacts with the bone-conduction speaker (72) when the user lay his or her head thereon. Thus, the device does not disturb the rolling over in a way the headphone does. Nevertheless, because the cushioning body (73) is formed of polyurethane and relatively rigid and has a skin layer, vibration of the bone-conduction speaker transmits to the cushioning body (73) as indicated by ripple lines in the figure. Then, vibration of the cushioning body (73) is converted to that of air in a manner the cushioning body (73) acts as a speaker, so as to cause air-conduction sound as indicated by ripple lines in the figure. Thus, problem of sound leakage remains.

In order to restrain occurrence of the air-conduction sound, conceivable is a way shown in FIG. 11, in which each of the bone-conduction speakers (72) is placed on a vibration-isolating body (75) filled with viscous liquid. The vibration-isolating body (75) dampens the vibration from the bone-conduction speakers (72) as to relieve vibration transmittance to the cushioning body (73) and to a pillow underneath of the cushioning body. Nevertheless, the vibration-isolating body (75), due to being formed of a bag filled with gel-state solution, increases production cost. Moreover, when the bag is busted by mechanical shock or the like, the gel-state solution leaks out as to mess up an outer covering (4) and nearby of the pillow.

Present invention is made in view of the above and aimed to provide a bone-conduction speaker device which makes no leakage of sound annoying the other and does not restrain posture and rolling-over motion of the user when lying on a bed or sitting deeply on a sofa, and which makes highly reliable and excellent way of transmission and receiving of sound signal as to enable listening of music or the like while undergoing almost no restriction on places or locations of using the device.

### DISCLOSURE OF THE INVENTION

According to the bone-conduction speaker device of claim 1 of the invention, the device is comprised of: a transmitter for being inputted with sound signal, converting the sound signal into output of infrared signal and then transmitting the infrared signal; a receiver for receiving the infrared signal and demodulating it into the sound signal; a bone-conduction speaker for receiving and amplifying the sound signal and outputting it as sound vibration; and an elastic cushioning body shaped as a pad and holding on its surface the bone-conduction speaker, thereby forming a pad embedded with the bone-conduction speaker; said receiver being provided with a plurality of photo-acceptors that are arranged on fringe of the elastic cushioning body and spaced apart from each other.

By the invention, leakage of sound is restrained as not to annoy the other, and the user undergoes no restriction on his or her posture for the rolling over or for seating, while listening to the music or the like. Moreover, restriction on inputting of sound signal into the bone-conduction speaker is greatly relieved as to improve reliability on signal inputting.

### BRIEF DESCRIPTION OF DRAWINGS

FIG. 1 is a perspective view of a pad embedded with a bone-conduction speaker, showing one embodiment of the present invention;

FIG. 2 is a sectional view of a state in that head of the user is laid on the pad of FIG. 1;

FIG. 3 is a block diagram showing transmitter and receiver in respect of FIG. 1;

FIG. 4 is a plan view of the pad embedded with a bone-conduction speaker shown in FIG. 1;

FIG. 5 is a side view showing an embodiment of the transmitter, of the present invention;

FIG. 6 is a side view of the pad embedded with a bone-conduction speaker shown in FIG. 1;

FIG. 7 is a set of graphs for comparing (a) an invention-wise cushioning body, (b) a vibration-isolating body filled with gel-state solution and (c) a conventional polyurethane foam;

FIG. 8 is sectional views showing another embodiment of the present invention, FIG. 8(a) shows the pad in an isolated state and FIG. 8(b) shows a state in that head of the user is laid on the pad;

FIG. 9 is a sectional view showing the pad of a still other embodiment of the present invention;

FIG. 10 is a sectional view showing construction of conventional pillow embedded with bone-conduction speakers; and

FIG. 11 is a sectional view showing a conventional construction in which bone-conduction speakers are disposed on vibration-isolating bodies.

### BEST MODE FOR CARRYING OUT THE INVENTION

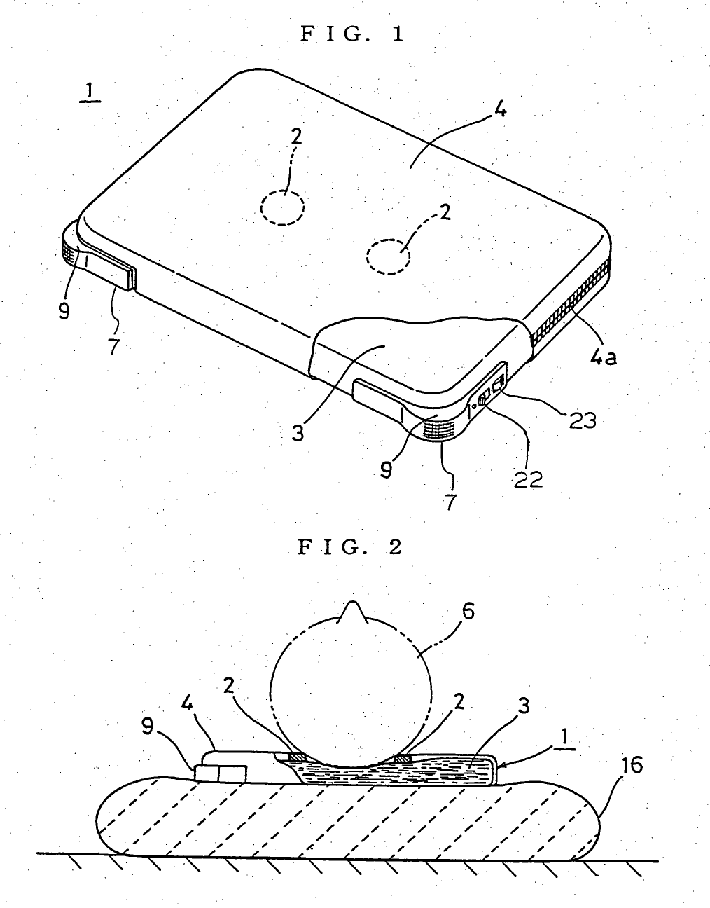

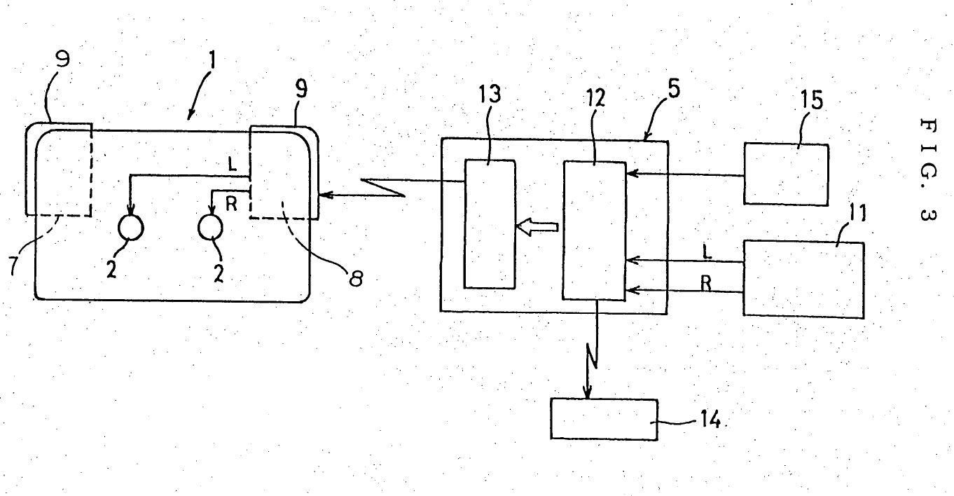

An embodiment of the present invention is explained by use of the drawings. FIG. 1 shows a perspective view of a pad (1) embedded with bone-conduction speakers (2), or speaker-embedded pad (1); and FIG. 2 shows the pad when being used. The speaker-embedded pad (1), which makes up a sound-signal receiver, is comprised of; an elastic cushioning body (3) on surface of which bone-conduction speakers (2) are disposed; and a outer covering (4) that wraps up the cushioning body and the speakers.

The bone-conduction speakers directly transmits sound from a sound-source transmitter (5) shown in the block diagram of FIG. 3, as a sound vibration, to head (6) of the user; so as to make the sound reach the user via bone conduction even when he or she has auditory difficulties. At least two speakers (2) are arranged on the elastic cushioning body (3) along its longitudinal direction so that head (6) of the user surely contacts with at least one of the bone-conduction speakers even when the user rolls over on the bed.

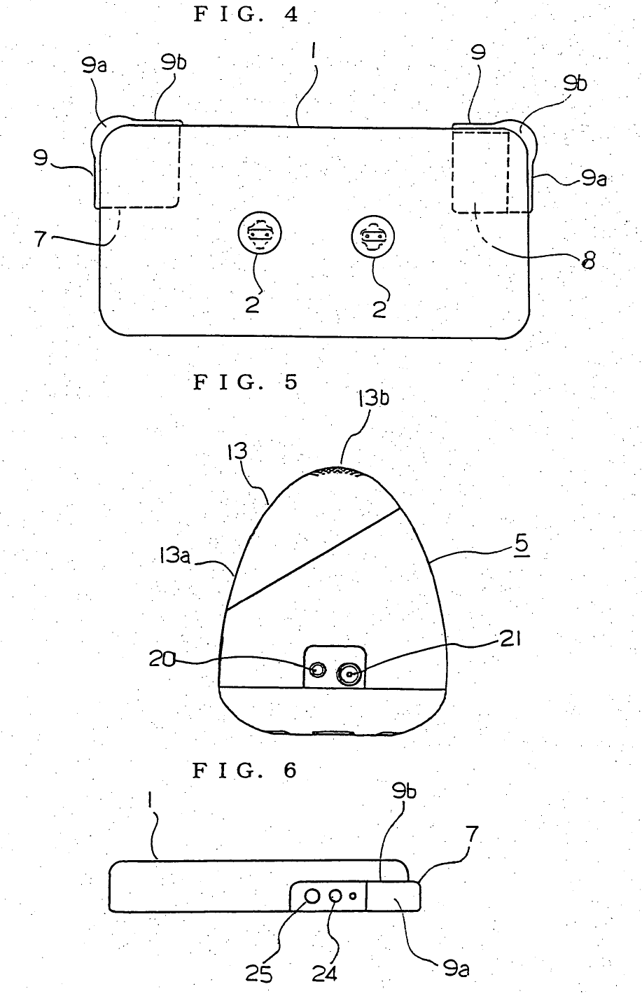

Signal receiver (7) of the speaker-embedded pad (2), which is for receiving sound signal, is constructed as follows as clearly seen from FIG. 4 that is a plan view of the speaker-embedded pad (1). Photo-acceptor (9) formed of photodiode is disposed on each of two corners of the speaker-embedded pad (1), that is, on both ends of rear side on plan-view-wise outline of the speaker-embedded pad. Each photo-acceptor (9) is covered by a photo-acceptor cover that is tinted with smoke color, and is able to receive sound signal consisting of infrared rays from any of sideward and upward. The photo-acceptor cover is formed of; a side-face part (9a) extending between two end faces on the corner in a manner jutting out from the corner toward outside; and upper-face part (9b).

Light emitting part (13), which is infrared-signal transmitting part on the sound source transmitter (5), is constructed as follows as shown in FIG. 5. Upper portion of housing of the sound source transmitter (5) is formed as substantially spherical. The light emitting part (13) has a sideward portion (13a) and an upward portion (13b) for enabling sideward and upward emitting of infrared signal. Lower part of housing of the sound-source transmitter (5) is provided with; a connector terminal (20) for connecting with sound source (11) such as radio-cassette recorder or the like; and an electricity-charging terminal (21) for connecting with AC (alternate current) adaptor (power converter).

At one of the ends of plan-view-wise rear side (rear fringe) of the pad (1), DC (direct current) power source (8) using a rechargeable battery is disposed. The photo-acceptors (9) on the speaker-embedded pad (1) receives infrared signal emitted from the light emitting part (13) on the sound-source transmitter (5) and generate driving signal for driving the bone-conduction speakers (2) on basis of received sound signal. At a side of the photo-acceptors (9), disposed are a power source switch (22), a tonal volume switch (23) and the like.

The sound-source transmitter (5) has; a sound amplifier (12) for amplifying a sound signal inputted from microphone or from a television set, or a CD or audio cassette player with radio receiver, or the like; and a light-emitting or signal-transmitting part (13) comprised of infrared emitting LED (light emitting diode) for transmitting the sound signal having been amplified. The sound-source transmitter (5) is to be controlled by a remote controller (14) so that the user may control the transmitter even while lying on a bed. Other than the inputting from the sound source (11), the sound source transmitter (5) is also inputted with signal from a clock (15) having timer function or alarming function. Thus, based on the signal from the clock (15), alarming motion may be made by imparting a vibration on head (6) of the user, or timer function may be implemented.

When stereo sound is inputted from the sound source (11), stereo sound signal is able to be transmitted from the signal-transmitting or light-emitting part (13) to the photo- or signal-acceptors (9). For such occasion, the photo-acceptors (9) preferably have an automatic switching circuit for switch-wise utilizing the bone-conduction speakers (2) on basis of inputted signals, as switched between modes for monaural sound and stereo sound.

In a normal state, the transmitting from the sound source (11) to the transmitter (5) is made by a cable attached on the line-in terminal (20). When the cable is detached, the inputting of the sound signal is automatically switched to that through a built-in microphone, which then receives sound.

The elastic cushioning body (3) is formed by non-woven fabric(s) in which fibers formed of polyester resin are bonded together by use of adhesive or by fusion, as shaped in a pad having a prescribed surface area and thickness. As shown in FIG. 2, the surface area of the elastic cushioning body (3) is set at dimensions of 30 cm in right-left direction and 15 cm in perpendicular direction. Such a surface area is larger than spacing for the bone-conduction speakers (2) that are arranged in a manner that any among them contacts with the head of the listener when he or she lies on a bed. Thickness of the elastic cushioning body (3) is set properly in a way enabling follows, and at 25 mm for example; protecting the bone-conduction speakers (2); giving comfortable cushioning when the head (6) is laid thereon as to eliminate uneasiness due to embedding of the speakers; absorbing vibration of the speaker as to restrain occurrence of air-conduction sound or, namely, sound leakage; and giving comfortable feeling on use even when the speaker-embedded pad (1) is laid on a pillow (16).

The above constructions enables following for example. The listener or user lays his or her head (6) on the speaker-embedded pad (1) placed on a pillow (16), and turns on power of the speaker device by use of remote controller (14) or the like. Then, sound signal inputted from the sound source (11) is inputted to the transmitter (5) through a cable, and further transmitted to the photo-acceptors (9) on the signal receiver (7) by way of infrared LED signal emitted from the light emitting part (13). Subsequently, sound vibration from the bone-conduction speaker (2) is transmitted to the head (6) of the user. Thus, even one having hearing difficulty is able to hear the sound or music, needless to say to one having no hearing difficulty.

During such use or listening, the speaker-embedded pad (1) sinks into the pillow (16) due to weight of the head, thus sideward portions (9a) of the photo-acceptors (9) might be covered as shielded from the light. Even in such occasion, the upper portion (9b) of the photo-acceptors (9) enables receiving of the signal. Moreover, even when one of the photo-acceptors (9) is totally covered by head hair of the user, the other one of the photo-acceptors (9) receives signal light by way of sideward portion (9a) or upward portion (9b).

As for the sound-source transmitter (5), even when light path from its sideward part is interrupted by fringe of the bedclothes or the like, infrared light emitted from spherical upper part (13b) of the light-emitting transmitter part (13) reaches the light-receiving sideward portion (9a) or upward portion (9b) without hindrance, by way of reflection on the ceiling.

As shown in FIG. 6, the speaker-embedded pad (1) is provided with recharging terminal (24) for connecting with AC adaptor for recharging the battery as well as a connector terminal (25) for inputting the sound signal, on side of the DC battery (8) that is disposed at near of the either end of the rear side on plan-view-wise outline of the pad. Through the connector terminal (25) as a jack, sound signal from the sound source (11) may be directly inputted to photo-acceptors (9) of the speaker-embedded pad (1) so that the speaker device may be played without using the sound source transmitter (5) when to listen to the music or the like.

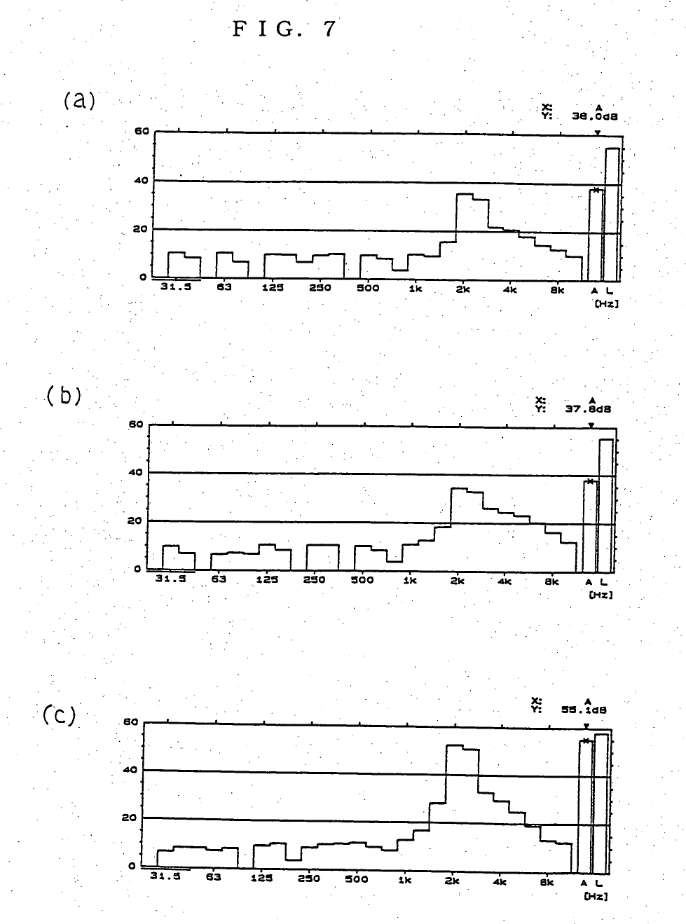

FIG. 7 shows data on generation of air-conducting sound from the elastic cushioning body (3) and from the other cushioning body for comparison, when same level of sound vibration is applied to the cushioning bodies. Each abscissa represents frequency in a range of 25 Hz to 10 KHz, while each ordinate represents sound pressure level (dB). FIG. 7 (a) shows data for the elastic cushioning body (3) formed of non-woven fabric according to the invention; FIG. 7 (b) shows data for the vibration-isolating body (75) filled with gel-state solution; and FIG. 7 (c) shows data for the polyurethane foam as a conventional cushioning body.

For each of these cushioning bodies, air-conduction sound at around 2 KHz is generated, as seen from the results of the FIG. 7. The cushioning body formed of non-woven fabric exhibited an effect of relieving the air-conduction sound in a level substantially same with that of the conventional vibration-isolating body (75), as seen from FIG. 7 (a) and FIG. 7 (b). Comparison of FIG. 7 (a) and FIG. 7 (c) reveals that the effect of relieving the air-conduction sound is more remarkable for the cushioning body of non-woven fabric than that of the polyurethane foam as a conventional cushioning body; and difference in overall (OA) value is around 15 dB.

Reasons of these results are considered to be as follows. The polyurethane foam has connected cell structure and, thereby, wall faces of the cells are interconnected so that spaces in the cells are contacted with each other by a large area as to facilitate conduction of the vibration. To contrary, the cushioning body (3) of non-woven fabric according to the invention has a structure in which fibers are overlaid with each other and which thus cause friction between the fibers as to convert vibration from the speakers into heat energy. Thus, the air-conduction sound is dampened. Moreover, such vibrating fibers are linear and thus, the vibration is relatively difficult to be converted to air vibration, compared to the polyurethane foam in a flat shape. Thus, generation of the air-conduction sound is relieved.

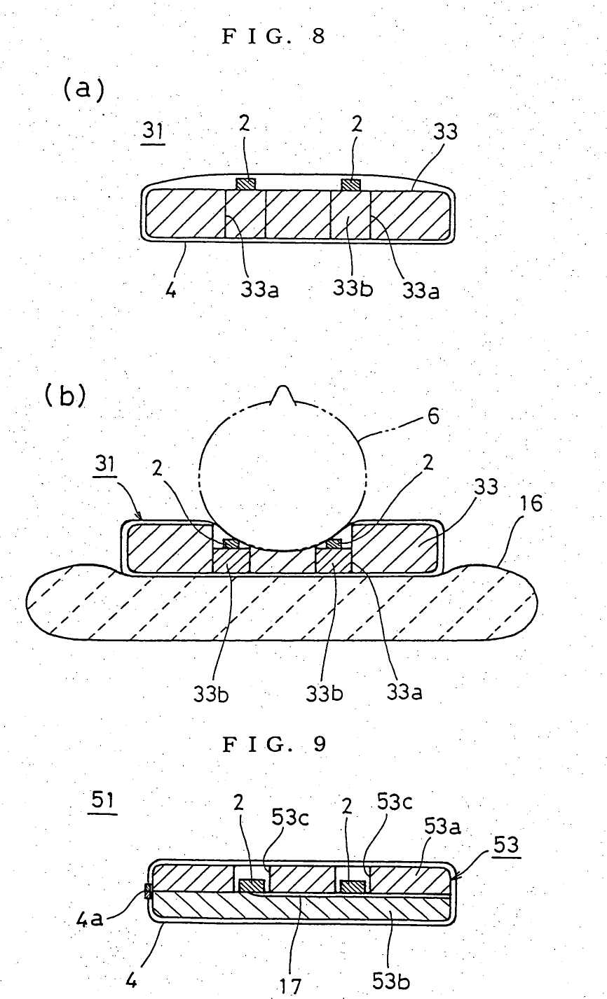

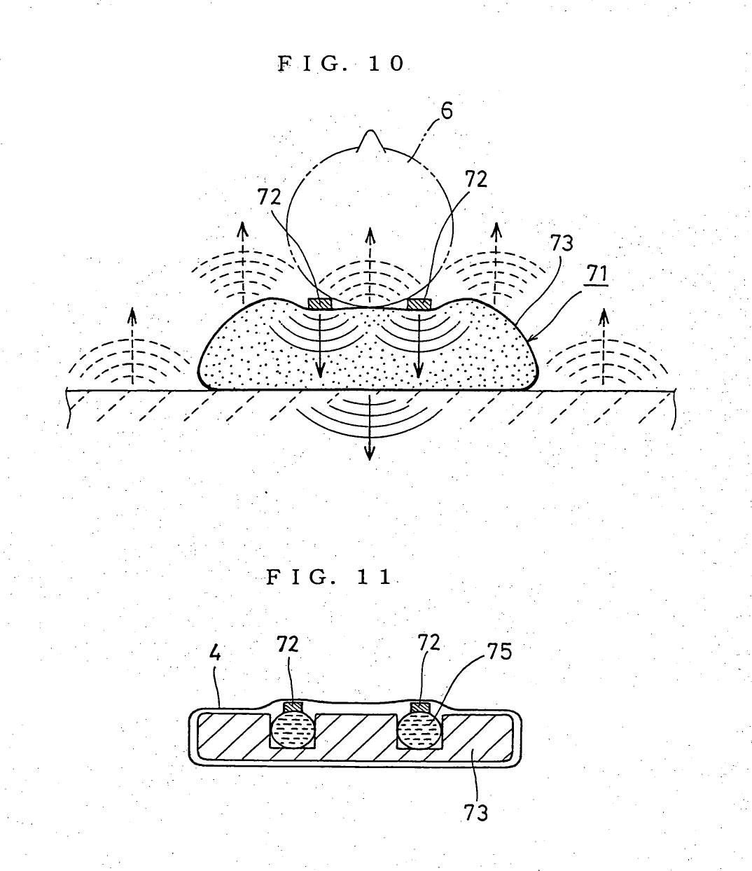

In following, another embodiment of the invention is illustrated. FIG. 8 (a) for this embodiment has same referential marks or numerals as in the figures for previous embodiment for elements respectively identical. As shown in FIG. 8 (a), a pad (31) embedded with the bone-conduction speakers (2) is constructed as follows. On an elastic cushioning body (33), a ring-shaped slit (33a) is formed as to enclose nearby of the bone-conduction speakers (2). When the pad (31) is laid on a pillow (16) and the head (6) is further laid thereon, the bone-conduction speakers (2) and a nearby part (33b) of the cushioning body at inside of the slit (33a) are depressed as strained, by weight of the head, as to cave in within other part of the elastic cushioning body (33).

Resultantly, as shown in FIG. 8 (b), relieved is hitting between the head (6) of the user and the bone-conduction speakers (2) jutting out from surface of the cushioning body (33). Thus, comfortability for the user is improved; and condition of the sound is kept to be excellent. Moreover, fibers of the elastic cushioning body (33) are discontinuous at the slit (33a); and the bone-conduction speakers (2) and its nearby part (33b) of the cushioning body at inside of the slit (33a) are not connected to other part of the cushioning body (33). Thus, conduction of the vibration is interrupted at the slit (33a) or boundary between the nearby part and the other part of the cushioning body (33), and thereby, generation of air-conduction sound is further restrained.

FIG. 9 shows a still other embodiment of the invention, in which referential marks are attached in same manner as previous embodiments. The elastic cushioning body (53) is constructed as severed to upper and lower parts, or upper and lower cushioning bodies (53a and 53b). Through holes (53c) are formed on the upper cushioning body (53a) with a prescribed spacing with each other; and the bone-conduction speakers (2) are embedded in the through holes (53c). Lead wires (17) connected to the speakers (2) are sandwiched between the upper and lower cushioning bodies (53a and 53b) and are connected to the photo- or signal-acceptors (9).

By such construction, the bone-conduction speakers are laid on the lower cushioning body (53b) at inside of the through holes (53c) on the upper cushioning body (53a), and thereby, may be placed to be flush with or slightly underneath of upper-face contour of the elastic cushioning body (53). Thus, hitting against the head (6) of the user is relieved. Meanwhile, the lead wires (17) run between the upper and lower cushioning bodies (53a and 53b) and thus, are surely and easily held as fixed and protected from external force.

The outer covering (4) is in a shape of bag and has a zip-fastener (4a) at an edge of the bag as to be freely detachable and re-attachable on main body of the speaker-embedded pad. Thus, when soiled with dirt, the outer covering (4) may be detached to be washed or replaced with new one. Though not shown, attachment strips or belts may be disposed on the outer covering (4), so as to be freely and easily attached on not only a pillow (16) but also a backrest sheet on a sofa or a headrest in a passenger car.

### INDUSTRIAL APPLICABILITY

By the bone-conduction speaker device of the invention, even one having hearing difficulties, as well as one having fair hearing ability, may listen to music. Moreover, restrictions or hamperings on inputting of sound signals to the bone-condition speakers are relieved.

What is claimed is:

1. A bone-conduction speaker device comprised of: a transmitter for being inputted with sound signal, converting the sound signal into output of infrared signal and then transmitting the infrared signal; a receiver for receiving the infrared signal and demodulating it into the sound signal; a bone-conduction speaker for receiving and amplifying the sound signal and outputting it as sound vibration; and an elastic cushioning body shaped as a pad and holding on its surface the bone-conduction speaker, thereby forming a pad embedded with the bone-conduction speaker; said receiver being provided with a plurality of photo-acceptors that are arranged on fringe of the elastic cushioning body and spaced apart from each other.

2. A bone-conduction speaker device according to claim 1, wherein said photo-acceptors jut out from outline of the pad embedded with the bone-conduction speaker and is able to receive the infrared signal from sideward and upward.

3. A bone-conduction speaker device according to claim 1, wherein light emitting part of the transmitter is able to emit the infrared signal to sideward and upward.

4. A bone-conduction speaker device according to claim 1, wherein the pad embedded with the bone-conduction speaker is provided with a connector terminal for inputting the sound signal through a wire line.

5. A bone-conduction speaker device according to claim 1, wherein the elastic cushioning body shaped in a pad is formed of a non-woven fabric that is formed by fusion-wise bonding of resin fibers.

6. A bone-conduction speaker device according to claim 5, wherein the elastic cushioning body is provided with a slit enclosing nearby of the bone-conduction speaker(s); and a part of the elastic cushioning body at inside of the slit along with the bone-conduction speaker(s) thereon is depressed as to cave in from other part of the elastic cushioning body when head of a user is laid thereon.

7. A bone-conduction speaker device according to claim 1, wherein the elastic cushioning body is severed to a plurality of cushioning bodies overlaid with each other; the bone-conduction speaker(s) is embedded in throughhole(s) of the uppermost one of the cushioning bodies; and lead wire(s) connected to the bone-conduction speaker(s) is sandwiched between upper and lower ones of the cushioning bodies.
